(19) United States
(12) Patent Application Publication
(10) Pub. No.: US 2026/0022069 A1
(43) Pub. Date: Jan. 22, 2026

(54) ORGANIC BINDER FOR TILING ADHESIVE

(71) Applicant: Dow Global Technologies LLC, Midland, MI (US)

(72) Inventors: Rene Kiesewetter, Wietzendorf (DE); Margarita Perello, Madrid (ES); Anette Wagner, Walsrode (DE)

(21) Appl. No.: 18/993,042

(22) PCT Filed: Jul. 26, 2023
(86) PCT No.: PCT/US2023/070987

§ 371 Date: Jan. 10, 2025

Related U.S. Application Data
(60) Provisional application No. 63/393,367, filed on Jul. 29, 2022.

(51) Int. Cl. C04B 28/04; C04B 14/04; C04B 40/00; C04B 111/00

(52) U.S. Cl. CPC C04B 28/04; C04B 14/047; C04B 40/0039; C04B 2111/00637

(57) ABSTRACT

In mortars used for tile adhesion that contain an organic binder, properties such as adhesion after water immersion can be improved by adding a small amount of porous aluminosilicate, such as zeolite.

### FIELD

This invention relates to the field of cement-based tile adhesives.

### INTRODUCTION

Tiled surfaces typically comprise: (a) a substrate such as a wall or floor, (b) tiles and (c) an adhesive that binds the tiles to the substrate.

In many cases, the adhesive is a cement-based tile adhesive, which is often called a mortar. Mortars that are used for tiling frequently comprise the following dry ingredients, mixed with water: (a) a hydraulic binder (also called a “cement”), such as Portland cement; (b) an inorganic filler, such as sand; and (c) a water-dispersible organic binder. Some mortars contain further ingredients, such as cellulose ethers, starch ethers, inorganic or organic fibers, air-entraining agents, accelerators, retarders, superplasticizers and defoamers.

The organic binder performs several different functions in the mortar. The organic binder can increase the tensile strength and flexural strength of mortar. The organic binder can increase the toughness of the mortar and make it better able to resist cracking caused by temperature changes. The organic binder can increase the adhesion of the mortar to tiles and substrates.

The organic binder is typically sold in the form of a “redispersible powder”. The redispersible powders typically start as emulsions of the organic binder that can be dried to form a dry powder and can later be redispersed in water to form an emulsion again. In many embodiments, the redispersible powder contains both the organic binder and a surfactant to aid in forming the emulsion. Examples of organic binder polymers include acrylic copolymers, vinyl ester copolymers and styrene-butadiene (SB) copolymers. Examples of common vinyl ester copolymers include vinyl acetate-ethylene (VAE), ethylene vinyl acetate (EVA) and vinyl ester of versatic acid (VEOVA). Examples of surfactants include nonionic surfactants and polyvinyl alcohol.

The mortar must meet several different building specifications that are affected by the organic binder. In Europe, the standards are set out in EN 12004. The fundamental characteristics to be met by a normal setting mortar include minimum performance for:
Tensile adhesion strength after storage at room temperature;
Tensile adhesion strength after water immersion;
Tensile adhesion strength after heat aging;
Tensile adhesion strength after freeze-thaw cycles; and
Open time

Frequently, the highest levels of performance under these standards require the use of complex and expensive organic binders, such as terpolymers of ethylene, vinyl acetate and methyl methacrylate. It would be desirable to provide ways to improve the performance of mortars, and especially mortars that use more common and less-expensive organic binders.

### SUMMARY

A first aspect of the present invention is an organic binder composition comprising:
a) A water-dispersible organic binder suitable for use in tiling mortar; and
b) From 1 to 10 weight percent of a porous aluminosilicate compound, based on the weight of the organic binder.

A second aspect of the present invention is a process to use the formulation in first aspect to make a mortar, wherein the formulation is mixed with cement, a filler and water in an amount from 0.5 to 10 weight percent (based on the weight of dry ingredients, excluding the water) to form a mortar.

A third aspect of the present invention is a mortar comprising:
a) cement;
b) an inorganic filler;
c) from 0.5 to 10 weight percent of an organic binder suitable for use in tiling mortar;
d) from 0.05 to 2 weight percent of a porous aluminosilicate compound; and
e) water,
wherein all weight percentages are based on the weight of the dry ingredients (a)-(d), excluding the water.

A fourth aspect of the present invention is a process to use the mortar in the third aspect to affix tiles to a substrate, comprising the steps of:
a) applying the mortar to a substrate;
b) applying a plurality of tiles to the mortar on the substrate; and
c) permitting the mortar to set.

A fifth aspect of the present invention is a tiled surface comprising:
a) a substrate;
b) a plurality of tiles; and
c) a mortar adhering the tiles to the substrate, wherein the mortar contains: (1) cement, (2) an inorganic filler, (3) from 0.5 to 10 weight percent of an organic binder suitable for use in tiling mortar; and (4) from 0.05 to 2 weight percent of a porous aluminosilicate compound, wherein all weight percentages are based on the weight of ingredients (1)-(4).

We have discovered that the presence of a small amount of porous aluminosilicate compound blended with the mortar improves the water-immersion tensile strength of the mortar while retaining other desirable properties. In some embodiments, it is convenient for the porous aluminosilicate compound to be mixed with the organic binder before they are blended into the other ingredients in the mortar, although the invention also permits the porous aluminosilicate compound and organic binder to be added separately or blended with other ingredients.

### DETAILED DESCRIPTION

Compositions of this invention contain a water-dispersible organic binder. Generally, the water-dispersible organic binder is in the form a powder or particulates. In some embodiments, the organic binder contains an acrylic copolymer, vinyl ester copolymer or styrene-butadiene (SB) copolymer.

In some embodiments, the organic binder contains a vinyl ester copolymer. Examples of suitable vinyl ester copolymers are described in U.S. Pat. No. 6,890,975. In some embodiments, the vinyl ester copolymer is a vinyl acetate-ethylene (VAE) copolymer. In some embodiments, the vinyl ester copolymer is a vinyl ester of versatic acid (VEOVA) copolymer.

Vinyl ester copolymers contain repeating units derived from one or more vinyl ester monomers, such as vinyl acetate, vinyl propionate, vinyl butyrate, vinyl 2-ethylhexanoate, vinyl laurate, 1-methylvinyl acetate, vinyl pivalate, and vinyl esters of C-branched monocarboxylic acids having 9 to 11 carbon atoms, such as vinyl versatate. In some embodiments, the vinyl ester copolymer comprises vinyl acetate. In some embodiments, the vinyl ester copolymer comprises both vinyl acetate and vinyl esters of C-branched monocarboxylic acids having 9 to 11 carbon atoms: examples of such polymers are commercially available under the trademark VeoVa.

In some embodiments, the vinyl ester copolymer further comprises repeating units derived from ethylene or vinyl chloride. For example, vinyl ester-ethylene copolymers may contain at least 1 weight percent repeating units derived from ethylene or at least 5 weight percent or at least 10 weight percent, and vinyl ester-ethylene copolymers may contain at most 60 weight percent repeating units derived from ethylene or at most 50 weight percent.

In some embodiments, the vinyl ester copolymer further comprises repeating units derived from an acrylic or methacrylic ester such as n-butyl acrylate or 2-ethyl hexyl acrylate. For example, vinyl ester-acrylic ester copolymers may contain 30 to 90 weight percent repeating units derived from vinyl ester, 1 to 60 weight percent repeating units derived from acrylic ester and 1 to 40 weight percent repeating units derived from ethylene. In some embodiments, the vinyl ester copolymer comprises no measurable quantity of acrylic or methacrylic ester.

Vinyl ester copolymers may further contain a small quantity of repeating units derived from ethylenically unsaturated monocarboxylic acids or dicarboxylic acids or their anhydrides, ethylenically unsaturated carboxamides or carbonitriles, ethylenically unsaturated sulfonic acids and their salts and vinyl silanes. Examples of common comonomers in this group include ethylene, acrylic acid, methacrylic acid, acrylamide, acrylonitrile, vinyl trimethoxysilane, vinyl triethoxysilane, vinyl tripropoxysilane, vinyl triisopropoxysilane. In some embodiments, the vinyl ester copolymer contains 0 to 2 weight percent of repeating units derived from such comonomers, or 0 to 1 weight percent or 0.5 to 1 weight percent.

In some embodiments, the organic binder contains an acrylic copolymer. Examples of acrylic polymers include styrene acrylic polymers such as styrene acrylonitrile copolymer.

In some embodiments, the water-dispersible organic binder has a weight average molecular weight (Mw) of at least 300,000 Da or at least 350,000 Da or at least 400,000 Da. In some embodiments, the water-dispersible organic binder has a weight average molecular weight (Mw) of at most 2,000,000 Da or at most 1,500,000 Da or at most 1,200,000 Da.

In some embodiments, the water-dispersible organic binder has a glass-transition temperature of at least −30° C. or at least −20° C. or at least −10° C. or at least 5° C. or at least 15° C. In some embodiments, the water-dispersible organic binder has a glass-transition temperature of at most 40° C. or at most 30° C. or at least 25° C.

In many embodiments, the water-dispersible organic binder further comprises a surfactant. In some embodiments, the surfactant is an anionic surfactant. Examples of nonionic surfactants include nonylphenol ethoxylates and fatty (C₆ to C₃₀) alcohol ethoxylates, such as TERGITOL™ 15-S-40 and TERGITOL™ NP10, which are commercially available from The Dow Chemical Company

In some embodiments the surfactant is poly-vinyl alcohol (PVOH). PVOH is a polyvinyl acetate in which most of the acetate groups have been hydrolyzed to alcohol groups. In some embodiments, the PVOH is at least 70% hydrolyzed or at least 80% hydrolyzed or at least 85% hydrolyzed or at least 87% hydrolyzed. In some embodiments, the PVOH is at most 95% hydrolyzed or at most 90% hydrolyzed or at most 88% hydrolyzed. In some embodiments, a 4% solution of the PVOH in water has a viscosity of at least 2 mPa·s or at least 3 mPa·s or at least 4 mPa·s. In some embodiments, a 4% solution of the PVOH in water has a viscosity of at most 40 mPa·s or at most mPa·s or at most 26 mPa·s. Examples of suitable PVOH have a weight average molecular weight (Mw) of at least 15,000 or at least 20,000. Examples of suitable PVOH have a weight average molecular weight (Mw) of at most 150,000 or at most 120,000. Examples of suitable PVOH include PVOH 04-88 and PVOH 26-88, which are commercially available.

In some embodiments, the organic binder and surfactant are selected such that the organic binder forms an emulsion with a particle size of at least 200 nm or at least 400 nm or at least 500 nm or at least 600 nm. In some embodiments, the organic binder and surfactant are selected such that the organic binder forms an emulsion with a particle size of at most 1000 nm or most 800 nm.

In some embodiments, the organic binder and surfactant are selected such that the organic binder forms an emulsion which is stable in a cementitious environment. The cement used in mortars creates an alkaline environment that is high in calcium ion. This environment can cause some emulsions to break down. Other combinations of organic binder and surfactant are known form stable emulsions in this environment, and the combinations that form stable emulsions may be advantageously used in mortars of the present invention.

It will be recognized that nominally dry powders may contain a small amount of moisture. In some embodiments, the water-dispersible organic binder contains no more than 5 weight percent moisture or no more than 4 weight percent or no more than 3 weight percent or no more than 2 weight percent or no more than 1 weight percent. In some embodiments, the water dispersible organic binder may contain no detectable moisture content (0 weight percent).

Examples of suitable water-dispersible organic binders are commercially available, such as under the DOW™ Latex Powder 2000 and DOW™ Latex Powder 2001 trademarks and under the VaVeova and VaE-Veova trademarks. Other water-dispersible organic binders can be made in aqueous dispersion by emulsion copolymerization of vinyl ester monomers and ethylene monomer according to known processes, such as are described in Lindemann, Vinyl Acetate/Ethylene Emulsion Copolymers, Paint Manufacture, September 1968, at 30-36, and U.S. Pat. No. 5,576,384 and US Application 2009/0069495 A1. The resulting dispersion can be spray-dried to produce a redispersible powder.

Compositions of this invention also contain a porous aluminosilicate compound.

In some embodiments, the porous aluminosilicate compound has an average pore size of at least 3 Å or at least 3.75 Å or at least 4 Å. In some embodiments, the porous aluminosilicate compound has an average pore size of at most 100 Å or at most 50 Å or at most 25 Å or at most 20 Å or at most 15 Å.

In some embodiments, the porous aluminosilicate compound has an average pore volume of at least 5 cm³/g or at least 10 cm³/g. In some embodiments, the porous aluminosilicate compound has an average pore volume of at most 60 cm³/g or at most 40 cm³/g.

In some embodiments, the porous aluminosilicate compound has a Brunauer-Emmett-Teller (BET) surface area of at least 100 m²/g or at least 200 m²/g or at least 300 m²/g or at least 400 m²/g or at least 500 m²/g. In some embodiments, the porous aluminosilicate compound has a BET surface area of at most 2000 m²/g or at most 1500 m²/g or at most 1000 m²/g or at most 800 m²/g or at most 600 m²/g.

In embodiments, the porous aluminosilicate compound may have an Si/Al molar ratio from 1 to 1000. All individual values and subranges of a molar ratio from 1 to 1000 are disclosed and included herein, including from 1 to 100, from 1 to 200, from 1 to 300, from 1 to 400, from 1 to 500, from 1 to 600, from 1 to 700, from 1 to 800, from 1 to 900, from 100 to 1000, from 200 to 1000, from 300 to 1000, from 400 to 1000, from 500 to 1000, from 600 to 1000, from 700 to 1000, from 800 to 1000, or from 900 to 1000.

Examples of suitable porous aluminosilicate compounds include zeolites, feldspar, sodalite and octahedrally coordinated aluminum, such as andalusite, kyanite and sillimanite. In certain embodiments, the porous aluminosilicate compound is a zeolite.

In some embodiments, the zeolite has a silica to alumina ratio (SiO₂/Al₂O₃) of at least 1 or at least 1.5 or at least 1.7 or at least 1.8 or at least 1.9 or at least 2. In some embodiments, the zeolite has a silica to alumina ratio (SiO₂/Al₂O₃) of at most 10 or at most 5 or at most 3 or at most 2.5 or at most 2.3 or at most 2.2.

In some embodiments, the zeolite has static water adsorption capacity (at 25° C. and 50% relative humidity) of at least 15 weight percent or at least 18 weight percent or at least 20 weight percent or at least 21 weight percent. In some embodiments, the zeolite has static water adsorption capacity (at 25° C. and 50% relative humidity) of at most 50 weight percent or at most 35 weight percent or at most 30 weight percent or at most 25 weight percent.

In some embodiments, the zeolite is a class A zeolite or a class X zeolite. Examples of suitable class A zeolites include 3A, 4A and 5A zeolites. Examples of suitable class X zeolites include 13X zeolites. In some embodiments, the zeolite comprises a 4A zeolite.

Suitable zeolites are commercially available, such as under the Siolite trademark. Other zeolites are available in nature or can be manufactured by known processes such as are described in Introduction to Zeolite Science and Practice—3rd Revised Edition (J. Čejka, H. at al-editors) at Chapter 3 (Synthesis of Zeolites by Jihing Yu).

In some embodiments, the weight ratio of porous aluminosilicate compound to organic binder (both dry) is at least 1 weight percent or at least 2 weight percent or at least 2.5 weight percent or at least 3 weight percent or at least 4 weight percent or at least 5 weight percent. In some embodiments, the weight ratio of porous aluminosilicate compound to organic binder (both dry) is at most 10 weight percent or at most 9 weight percent or at most 8 weight percent or at most 7 weight percent or at most 6 weight percent or at most 5 weight percent.

In some embodiments, the porous aluminosilicate compound and organic binder are added separately to the mortar. One or both of the organic binder and the porous aluminosilicate compound may be blended, individually or together, into the cement or the filler or the water before the full mortar is blended, or the other ingredients may be blended together first and then the organic binder and/or porous aluminosilicate compound may be added.

In some embodiments, it may be convenient to blend the organic binder and the porous aluminosilicate compound together before they are added to the rest of the mortar to form an organic binder composition.

Optionally, the organic binder composition may contain other additives, such as additives mentioned below for mortar, or additional emulsifier or emulsion stabilizer such a polyvinyl alcohol or anticaking and flow aids such as kaolin, calcium carbonate or silica.

In some embodiments, the organic binder composition may be premixed with cement or other additives for the mortar, to form a master-batch that contains a high concentration of the organic binder composition. The master-batch may later be blended with the remainder of the mortar to achieve the desired concentration of organic binder composition.

Together or separately, the organic binder and porous aluminosilicate compound are added to a mortar that contains cement and an inorganic filler.

The ASTM recognizes five categories of cement: Type 1 (ordinary Portland cement); Type 2 (moderate sulfate resistant cement); Type 3 (rapid hardening cement), Type 4 (low heat cement) and Type 5 (high sulfate resistant cement). Any of these cements may be used in the mortar. In some embodiments, the cement is ordinary Portland cement. In some embodiments, the cement is a variation of ordinary Portland cement, known as white cement. In some embodiments, the cement contains less than 25 weight percent alumina cement, or less than 20 weight percent, or less than 15 weight percent or less than 10 weight percent or less than 5 weight percent or essentially 0 weight percent. Suitable cements are commercially available.

The mortar should contain enough cement to be effective as a tile adhesive. In some embodiments, the mortar contains at least 5 weight percent cement or at least 10 weight percent cement or at least 15 weight percent cement or at least 20 weight percent cement or at least 22 weight percent or at least 25 weight percent or at least 28 weight percent or at least 30 weight percent, based on the dry ingredients in the composition and excluding water. In some embodiments, the mortar contains at most 60 weight percent cement or at most 50 weight percent or at most 45 weight percent or at most 40 weight percent or at most 35 weight percent, based on the dry ingredients in the composition and excluding water.

Examples of inorganic fillers include silica sand, quartz sand, kaolin, calcium carbonate, magnesium carbonate, talc or mixture thereof. Suitable inorganic fillers are commercially available.

In some embodiments, the mortar contains at least 25 weight percent filler or at least 30 weight percent or at least 35 weight percent or at least 40 weight percent or at least 45 weight percent, based on the dry ingredients in the composition and excluding water. In some embodiments, the mortar contains at most 95 weight percent filler or at most 90 weight percent or at most 85 weight percent or at most 80 weight percent or at most 75 weight percent or at most 70 weight percent or at most 65 weight percent or at most 60 weight percent, based on the dry ingredients in the composition and excluding water.

In some embodiments, the mortar further contains pozzolans such as fly ash, calcined kaolin, pumices, or fumed silica. In some embodiments, the mortar contains at least 5 weight percent pozzolans, or at least 10 weight percent or at least 15 weight percent. In some embodiments, the mortar contains at most 50 weight percent pozzolans, or at most 40 weight percent or at most 30 weight percent. Pozzolans and their use in mortars and concrete are well-known and described in U.S. Pat. No. 9,181,131B2

In addition to cement and filler, some embodiments of the mortar may optionally contain other ingredients, such as cellulose ethers, starch ethers, inorganic or organic fibers, air-entraining agents, accelerators, retarders, superplasticizers and defoamers.
Cellulose ethers, such as methyl cellulose, ethyl cellulose and methyl ethyl cellulose, can increase the water retention of the mortar and lengthen open time. Appropriate cellulose ethers are commercially available, such as under the WALOCEL™ OR METHOCEL™ trademark.
Starch ethers, such as hydroxypropyl starch ether, can improve the anti-sagging and anti-slip performance of the mortar, as well as lengthening open time and providing a smoother surface. Appropriate starch-ethers are commercially available, such as under the Aqualon trademark.
Fibers added to a mortar can improve its tensile strength. Examples of fibers include steel fibers, glass fibers, polymer fibers such as polypropylene or polyester, and natural fibers. In some embodiments, the fibers chopped short before they are added, such as to a length that provides an aspect ratio of 30 to 150. Suitable fibers are commercially available.
Air-entraining agents cause the formation of small air-bubbles in the mortar, which can improve its resilience under freeze-thaw cycles. Air-entrainment agents are frequently surfactants. Suitable air-entrainment additives are commercially available.
Accelerators speed the setting of the mortar. They may be especially useful in cold-weather application. Examples of common accelerants include calcium nitrate, calcium nitrite, calcium formate and certain aluminum compounds. Accelerator formulations with instructions for their use are commercially available.
Retarders slow the setting time of the mortar. Examples of common retarders include calcium, sodium and ammonium salts of lignosulfonic acid, hydroxycarboxylic acids such as hydroxylic acid, carbohydrates, lead oxides, zinc oxides, phosphates, borates and fluorates. Retarder formulations with instructions for their use are commercially available.
Superplasticizers allow the production and use of mortar with lower water content. Examples of superplasticizers include sulfonated melamine-formaldehyde condensates, sulfonated naphthalene-formaldehyde condensates, modified lignosulfonates and polycarboxylates. Superplasticizer formulations with instructions for their use are commercially available.
Defoamers can reduce air-entrainment and voids in the mortar. Examples of defoamers include mineral oils, polyglycols and polyethersiloxanes. Defoamers with instructions for their use are commercially available.

In some embodiments, the mortar contains at most 20 weight percent of the other ingredients or at most 10 weight percent or at most 5 weight percent or at most 2 weight percent, based on the dry ingredients in the composition and excluding water. In some embodiments, the mortar contains no measurable content of the other ingredients (essentially 0 weight percent) or at least 1 weight percent or at least 2 weight percent, based on the weight of dry ingredients in the composition and excluding water.

For use, the cement, filler, organic binder, porous aluminosilicate compound and other ingredients (if any) are thoroughly mixed with water.

In some embodiments, the quantity of organic binder is at least 0.5 weight percent or at least 1 weight percent or at least 1.5 weight percent or at least 2 weight percent, based on the weight of dry ingredients in the composition and excluding water. In some embodiments, the quantity of organic binder is at most 10 weight percent or at most 8 weight percent or at most 6 weight percent or at most 5 weight percent, based on the weight of dry ingredients in the composition and excluding water.

In some embodiments, the quantity of porous aluminosilicate compound is at least 0.01 weight percent or at least 0.02 weight percent or at least 0.05 weight percent or at least 0.08 weight percent or at least 0.1 weight percent, based on the weight of dry ingredients in the composition and excluding water. In some embodiments, the quantity of porous aluminosilicate compound is at most 2 weight percent or at most 1.5 weight percent or at most 1 weight percent or at most 0.75 weight percent or at most 0.5 weight percent or at most 0.3 weight percent or at most 0.25 weight percent, based on the weight of dry ingredients in the composition and excluding water.

The best quantity of water varies depending on the ingredients and their intended use, and can be readily determined by experimentation. In some embodiments, the amount of water is at least 20 weight percent of the weight of the dry ingredients, or at least 22 weight percent or at least 24 weight percent or at least 26 weight percent. In some embodiments, the amount of water is at most 60 weight percent of the weight of the dry ingredients, or at most 50 weight percent or at most 40 weight percent or at most 30 weight percent.

In some embodiments, the quantity of water is selected to provide a mortar that, when wet, is on the one-hand fluid enough that it can be applied smoothly to a substrate and is on the other hand viscous enough that it will hold tiles to the substrate without excessive slippage or falling of tiles before the mortar sets. In some embodiments, the mortar has a viscosity of at least 400 Pa·s or at least 450 Pa·s or at least 500 Pa·s or at least 525 Pa·s or at least 550 Pa·s. In some embodiments, the mortar has a viscosity of at most 800 Pa·s or at most 700 Pa·s or at most 650 Pa·s or at most 600 Pa·s.

In one embodiment, the completed product is a mortar that contains:
a) cement;
b) an inorganic filler;
c) from 0.5 to 10 weight percent of an organic binder;
d) from 0.05 to 2 weight percent of a porous aluminosilicate compound; and
e) water,
wherein all weight percentages are based on the weight of the dry ingredients (a)-(d), excluding the water. It may optionally further contain from 0 to 20 weight percent other additives as previously discussed. The selection and quantity of each ingredient may optionally reflect the embodiments and examples previously discussed.

Among other uses, the mortar can be used for ordinary tiling. First, the mortar is applied to a substrate. Second, tiles are pressed onto the applied mortar. Third, the mortar is allowed to set. Each of these steps is well-known and has been practiced for thousands of years.

Examples of appropriate substrates include any known rigid building material, such as drywall, wood, plaster or concrete. Examples of suitable tiles include any known tiles such as ceramic, glass, porcelain, stone or marble, terra cotta or concrete.

Average thickness of the mortar varies depending on a number of factors such as the smoothness of the substrate and the tiles and the intended use. In some embodiments, the mortar is applied with a thickness (when wet) of at least 2 mm or at least 3 mm or at least 4 mm. In some embodiments, the mortar is applied with a thickness (when wet) of at most 8 mm or at least 6 mm or at least 5 mm. Setting causes the mortar to shrink. In some embodiments, the set mortar is at least 1 mm thick or at least 1.25 mm or at least 1.5 mm. In some embodiments, the set mortar is at most mm thick or at most 4 mm or at most 3 mm.

Setting time for the mortar depends on many factors such as temperature, water content and ingredients of the mortar. In some embodiments, setting time is between 300 and 700 minutes. In some embodiments, it may be longer or shorter.

In some embodiments, the mortar provides a tensile adhesion after storage at room temperature, as defined in EN 12004, of at least 0.5 N/mm² or at least 0.75 N/mm² or at least 1 N/mm² or at least 1.2 N/mm² or at least 1.4 N/mm² or at least 1.45 N/mm². There is no maximum desired tensile adhesion, but in many embodiments, adhesion above 3 N/mm² or 2 N/mm² provides little added value.

In some embodiments, the mortar provides a water immersion tensile adhesion, as defined in EN 12004, of at least 0.5 N/mm² or at least 0.6 N/mm² or at least 0.7 N/mm² or at least 0.8 N/mm² or at least 0.9 N/mm² or at least 0.95 N/mm² or at least 1 N/mm². There is no maximum desired water immersion tensile adhesion, but in many embodiments, adhesion above 2 N/mm² or 1.5 N/mm² provides little added value.

In some embodiments, the mortar provides a heat-aging tensile adhesion, as defined in EN 12004, of at least 0.5 N/mm² or at least 0.75 N/mm² or at least 1 N/mm² or at least 1.2 N/mm² or at least 1.4 N/mm² or at least 1.6 N/mm² or at least 1.7 N/mm². There is no maximum desired heat-aging tensile adhesion, but in many embodiments, adhesion above 3 N/mm² or 2.5 N/mm² provides little added value.

In some embodiments, after open time of 20 minutes as defined in EN 12004, the mortar provides a tensile adhesion of at least 0.5 N/mm² or at least 0.75 N/mm² or at least 1 N/mm² or at least 1.2 N/mm² or at least 1.4 N/mm² or at least 1.6 N/mm² or at least 1.8 N/mm² or at least 1.9 N/mm². There is no maximum desired tensile adhesion for this test, but in many embodiments, adhesion above 3 N/mm² or 2.5 N/mm² provides little added value.

In some embodiments, after open time of 30 minutes as defined in EN 12004, the mortar provides a tensile adhesion of at least 0.5 N/mm² or at least 0.7 N/mm² or at least 0.9 N/mm² or at least 1.2 N/mm² or at least 1.28 N/mm² or at least 1.4 N/mm² or at least 1.6 N/mm². There is no maximum desired tensile adhesion for this test, but in many embodiments, adhesion above 3 N/mm² or 2 N/mm² provides little added value.

The process produces a tiled surface comprising:
a) a substrate;
b) a plurality of tiles; and
c) a mortar adhering the tiles to the substrate, wherein the mortar contains: (1) cement, (2) an inorganic filler, (3) from 0.5 to 10 weight percent of an organic binder suitable for use in tiling mortar; and (4) from 0.05 to 2 weight percent of a porous aluminosilicate compound, wherein all weight percentages are based on the weight of the dry ingredients (1)-(4).

Options and specific embodiments for the substrate, tiles and mortar are previously described, except the mortar has been allowed to set, so that it no longer contains the high level of water in the wet mortar. Ratios of dry ingredients are as previously described.

### EXAMPLES

### Test Methods

Parameters described in this application can be measured using the following measurements:

| Parameter | Test |
|---|---|
| Pore Volume and | ASTM D4365-19 Standard Test Method for |
| Surface Area | Determining Micropore Volume and Zeolite |
| | Area of a Catalyst |
| Particle Size of | Measured using laser diffraction with a |
| Emulsion | Beckman Coulter LS13320XR particle size |
| | analyzer |
| Surface area | Brunauer-Emmett-Teller (BET) test |
| Static Water | ASTM C1403-13 Standard Test Method for Rate |
| Adsorption Capacity | of Water Absorption of Masonry Mortars |
| Calcium Chloride | Procedure in U.S. Pat. No. 6,448,330 B1, col 11, |
| Stability Index | lines 40-64. |
| Glass Transition | ASTM E1356-08(2014) Assignment of the Glass |
| Temperature | Transition Temperatures by Differential |
| | Scanning Calorimetry |
| Tensile adhesion | 8.2 of EN 1348: 2007 |
| after storage at | |
| room temperature | |
| Tensile adhesion | 8.3 of EN 1348: 2007 |
| after water | |
| immersion | |
| Tensile adhesion | 8.4 of EN 1348: 2007 |
| after heat aging | |
| Tensile adhesion | EN 1346 |
| after extended | |
| open time | |

### Molecular Weight

Molecular weight/molecular weight distribution and a Mark-Houwink plot for branching structure analysis are measured using Triple Detector Gel Permeation Chromatography. The processes and equations utilized are described in U.S. Pat. No. 8,871,887. U.S. Pat. No. 8,871,887 is incorporated by reference. For the Gel Permeation Chromatography (GPC) processes (Conventional GPC, Light Scattering (LS) GPC, Viscometry GPC and gpcBR), a Triple Detector Gel Permeation Chromatography (3D-GPC or TDGPC) system is utilized. This system includes a Robotic Assistant Delivery (RAD) high temperature GPC system [other suitable high temperature GPC instruments include Waters (Milford, Mass.) model 150C High Temperature Chromatograph; Polymer Laboratories (Shropshire, UK) Model 210 and Model 220; and Polymer Char GPC-IR (Valencia, Spain)], equipped with a Precision Detectors (Amherst, Mass.) 2-angle laser light scattering (LS) detector Model 2040, an IR4 infra-red detector from Polymer ChAR (Valencia, Spain), and a 4-capillary solution viscometer (DP) (other suitable viscometers include Viscotek (Houston, Tex.) 150R 4-capillary solution viscometer (DP)). A GPC with these latter two independent detectors and at least one of the former detectors can be referred to as “3D-GPC” or “TDGPC,” while the term “GPC” alone generally refers to conventional GPC. Data collection is performed using software, e.g., Polymer Char GPC-IR. The system is also equipped with an on-line solvent degassing device, e.g., from Polymer Laboratories.

Eluent from the GPC column set flows through each detector arranged in series, in the following order: LS detector, IR4 detector, then DP detector. The systematic approach for the determination of multi-detector offsets is performed in a manner consistent with that published by Balke, Mourey, et al. (Mourey and Balke, Chromatography Polym., Chapter 12, (1992)) (Balke, Thitiratsakul, Lew, Cheung, Mourey, Chromatography Polym., Chapter 13, (1992)). Olexis LS columns is used. The sample carousel compartment is operated at 140° C. and the column compartment is operated at 150° C. The samples are prepared at a concentration of 0.1 grams of polymer in 50 milliliters of solvent. The chromatographic solvent and the sample preparation solvent is 1,2,4-trichlorobenzene (TCB) containing 200 ppmw of 2,6-di-tert-butyl-4methylphenol (BHT). The solvent is sparged with nitrogen. The polymer samples are gently stirred at 160° C. for four hours. The injection volume is 200 microliters. The flow rate through the GPC is set at 1 ml/minute.

For Conventional GPC, the IR4 detector is used, and the GPC column set is calibrated by running 21 narrow molecular weight distribution polystyrene standards. The molecular weight of the standards ranged from 580 g/mol to 8,400,000 g/mol, and the standards are contained in six “cocktail” mixtures. Each standard mixture had at least a decade of separation between individual molecular weights. The polystyrene standards are prepared at 0.025 g in 50 mL of solvent for molecular weights equal to, or greater than, 1,000,000 g/mol, and at 0.05 g in 50 mL of solvent for molecular weights less than 1,000,000 g/mol. The polystyrene standards are dissolved at 80° C., with gentle agitation, for 30 minutes. The number average molecular weight, the weight average molecular weight, and the z-average molecular weight are calculated from equations, e.g., as described in U.S. Pat. No. 8,871,887.

For the LS GPC, the Precision Detector PDI2040 detector Model 2040 is used. For 3D-GPC, absolute weight average molecular weight is calculated from equations, e.g., as described in U.S. Pat. No. 8,871,887. The gpcBR branching index is determined by calibrating the light scattering, viscosity, and concentration detector and subtracting the baselines. Integration windows are set for integration of the low molecular weight retention volume range in the light scattering and viscometer chromatograms that indicated the presence of detectable polymer from the refractive index chromatogram. Linear polyethylene standards are used to establish polyethylene and polystyrene Mark-Houwink constants. The constants are used to construct two linear references, conventional calibrations for polyethylene molecular weight and polyethylene intrinsic viscosity as a function of elution volume, e.g., as described in U.S. Pat. No. 8,871,887. To determine the gpcBR branching index, the light scattering elution area for the sample polymer is used to determine the molecular weight of the sample. Analysis is performed using the final Mark-Houwink constants, e.g., as described in U.S. Pat. No. 8,871,887.

### EXAMPLES

A series of dry mortars are made by mixing the ingredients listed in Table 1. In the case of Inventive Examples 1 and 2, all of the ingredients are mixed together to make a mortar. In the case of Inventive Examples 3 to 6, the organic binder polymer is mixed with zeolite to form a redispersible powder composition. The redispersible powder composition is further mixed with other mortar ingredients to make a mortar.

Comparative examples are also made. Comparative Example A and B are made using the procedure of Example 2, omitting the zeolite.

The compositions from Table 1 are thoroughly mixed with water as set out in Table 2 and are tested using the Test Methods listed above for mortar viscosity, wet mortar density, tensile adhesion strength after storage at room temperature, tensile adhesion strength after water immersion, tensile adhesion strength after heat aging, tensile strength after being open for 20 and 30 minutes, and setting time. The results for each test are listed in Table 2. A classification under EN 12004 is assigned to each mortar and listed in Table 2.

TABLE 1

| | | Inventive Examples | | | | | | Comparative | |
|---|---|---|---|---|---|---|---|---|---|
| Material | Supplier | 1 | 2 | 3 | 4 | 5 | 6 | A | B |
| Original Portland Cement 52.5R | Holcim | 35 | 35 | 35 | 35 | 35 | 35 | 35 | 35 |
| Silica sand F32 | Frechen | 29.50 | 29.50 | 29.5 | 29.5 | 29.5 | 29.5 | 29.50 | 29.50 |
| Silica sand F36 | Frechen | 30.00 | 30.00 | 30.5 | 30.5 | 30.5 | 30.5 | 30.00 | 30.00 |
| Calcium Formate | Lanxess | 0.50 | 0.50 | 0.5 | 0.5 | 0.5 | 0.5 | 0.50 | 0.50 |
| WALOCEL ™ M 10-35 cellulose | TDCC* | 0.50 | 0.50 | 0.5 | 0.5 | 0.5 | 0.5 | 0.50 | 0.50 |
| ether | | | | | | | | | |
| DOWSIL CP SHP 50 silicon powder | TDCC | | | | | | | | 0.225 |
| DLP 2000 ethylene vinyl acetate | TDCC | 4.275 | | | | | | 4.5 | 4.275 |
| copolymer powder | | | | | | | | | |
| DLP 2001 ethylene vinyl acetate | TDCC | | 4.275 | | | | | | |
| copolymer powder | | | | | | | | | |
| Zeolite 4A | Sigma- | 0.225 | 0.225 | | | | | | |
| | Aldrich | | | | | | | | |
| Redispersible Powder | | | | 4.5 | 4.5 | 4.5 | 4.5 | | |
| Contents of Redispersible Powder | | | | | | | | | |
| DLP 2001 ethylene vinyl acetate | | | | 97.5 | 95 | 97.5 | 95 | | |
| copolymer powder | | | | | | | | | |
| Siolite 4A zeolite | Grupo IQE | | | | | 2.5 | 5 | | |
| Siolite 13X zeolite | Grupo IQE | | | 2.5 | 5 | | | | |

*TDCC = The Dow Chemical Company
All quantities in Table 1 are weight percent.

TABLE 2

| | | Inventive Examples | | | | | | Comparative | |
|---|---|---|---|---|---|---|---|---|---|
| | Units | 1 | 2 | 3 | 4 | 5 | 6 | A | B |
| Water load | Wt % | 27 | 27 | 26 | 26 | 26 | 26 | 27 | 27 |
| Mortar viscosity | Pa · s | 564 | 534 | 505 | 573 | 539 | 568 | 550 | 586 |
| Wet mortar density | g/mL | 1.48 | 1.49 | 1.47 | 1.45 | 1.49 | 1.46 | 1.46 | 1.46 |
| Tensile Adhesion after Room | N/mm² | 1.41 | 1.14 | 1.49 | 1.38 | 1.50 | 1.47 | 1.52 | 1.42 |
| Temperature Storage | | | | | | | | | |
| Tensile Adhesion after Water | N/mm² | 1.03 | 1.01 | 1.02 | 1.0 | 1.0 | 0.99 | 0.95 | 0.91 |
| Immersion | | | | | | | | | |
| Tensile Adhesion after Heat | N/mm² | 1.65 | 1.28 | 1.91 | 1.88 | 1.84 | 1.85 | 1.7 | 1.54 |
| Aging | | | | | | | | | |
| Tensile Adhesion after 20 min | N/mm² | 1.66 | 1.18 | 1.69 | 1.88 | 1.75 | 1.72 | 1.81 | 1.65 |
| open | | | | | | | | | |
| Tensile Adhesion after 30 min | N/mm² | 1.10 | 0.72 | 1.28 | 1.28 | 1.32 | 1.21 | 1.27 | 1.19 |
| open | | | | | | | | | |
| Initial Setting Time | Min. | 641 | 613 | 54. | 577 | 546 | 547 | 575 | 426 |
| Final Setting Time | Min. | 772 | 745 | 636 | 674 | 642 | 654 | 711 | 537 |
| Total Setting Time | Min. | 131 | 132 | 91 | 97 | 96 | 107 | 130 | 109 |
| EN 120004 Classification | | C2E | C2E | | | | | C1E | C1E |

We claim:

1. An organic binder composition comprising:
(a) a water-dispersible organic binder suitable for use in tiling mortars; and
(b) from 1 to 10 weight percent of a porous aluminosilicate compound, based on the weight of the organic binder.

2. The organic binder composition of claim 1 wherein the water-dispersible organic binder comprises a polymer having a glass-transition temperature from −20° C. to 30° C.

3. The organic binder composition of claim 1 wherein the water-dispersible organic binder comprises a vinyl ester copolymer.

4. The organic binder composition of claim 1 wherein the water-dispersible organic binder comprises a vinyl acetate ethylene copolymer.

5. The organic binder composition of claim 1 wherein the porous aluminosilicate compound is a zeolite.

6. The organic binder composition of claim 5 wherein the porous aluminosilicate compound has an average pore size from 3 Å to 15 Å.

7. The organic binder composition of claim 5 wherein the porous aluminosilicate compound is a class A zeolite or a class X zeolite.

8. A process to use the organic binder composition of claim 1, wherein the organic binder composition of claim 1 is mixed with cement, a filler and water in an amount from 0.5 to 10 weight percent, based on the weight of dry ingredients excluding the water.

9. A mortar comprising:
(a) cement;
(b) an inorganic filler;
(c) from 0.5 to 10 weight percent of an organic binder suitable for use in tiling mortars;
(d) from 0.05 to 2 weight percent of a porous aluminosilicate compound; and
(e) water,
wherein all weight percentages are based on the weight of the dry ingredients (a)-(d).

10. The mortar of claim 9 wherein the organic binder is a vinyl ester copolymer.

11. The mortar in claim 9 wherein the porous aluminosilicate compound is a zeolite having an average pore size from 3 Å to 15 Å.

12. The mortar in claim 9 wherein the porous aluminosilicate compound is a class A or class X zeolite.

13. The mortar of claim 9 which has a tensile adhesion strength after water immersion of at least 1 N/mm² under the test in European standards EN 12004.

14. The mortar of claim 9 which has a tensile adhesion strength after 30 minutes open of at least 1.28 N/mm² under the test in European standards EN 12004.

15. A process to use the mortar in the mortar in claim 9 to affix tiles to a substrate, comprising the steps of:
(a) applying the mortar to a substrate;
(b) applying a plurality of tiles to the mortar on the substrate; and
(c) permitting the mortar to set.
